(19) United States
(12) Patent Application Publication
(10) Pub. No.: US 2023/0390592 A1
(43) Pub. Date: Dec. 7, 2023

(54) FIREFIGHTER IDENTIFICATION SYSTEM

(71) Applicant: John S. Williams, Canton, GA (US)

(72) Inventor: John S. Williams, Canton, GA (US)

(21) Appl. No.: 18/206,877

(22) Filed: Jun. 7, 2023

Related U.S. Application Data
(60) Provisional application No. 63/349,792, filed on Jun. 7, 2022.

(51) Int. Cl. A62B 9/00; G09F 3/02; G09F 3/10; G09F 13/20

(52) U.S. Cl. CPC A62B 9/006; G09F 3/02; G09F 3/10; G09F 13/20; G09F 2003/023; G09F 2003/0251; G09F 2003/0272; G09F 13/16

(57) ABSTRACT

A firefighter identification system for use with a firefighter's cylindrical air bottle includes a C-shaped metal band to be slipped or snapped onto the cylindrical air bottle and having an outer surface. Removable labels are placed on the C-shaped metal band. The removable labels can comprise flexible adhesive-backed labels or flexible magnetic labels. The removable labels are a combination of photoluminescent with reflective. The C-shaped metal band comprises a spring steel band and has flared ends to help ease the metal band over a cylindrical oxygen bottle.

### BACKGROUND

In the firefighting field, it is common for firefighters to carry some external identification so that others can see who they are or what firefighting group they belong to. It is common to use such a “pack identifier” in the form of a fabric patch attached to the firefighter's uniform or adhered to the oxygen bottle/air bottle that many firefighters carry into or around a burning building. Indeed, the oxygen bottle or air bottle is part of a self-contained breathing apparatus that firefighters often rely on for survival in a smoke-filled building or space. Typically, the fabric patch pack identifier can be sewn onto the uniform of the firefighter. Alternatively, this can take the form of a label which can be adhered to the air bottle via a retention strap. However, in use, the fabric patch (NOMEX) or adhesive label can become damaged by the heat from fires and frequently needs to be replaced. Also, as firefighters often are reassigned from one unit to another, and the change in assignment can require the pack identifier to be changed. Further, as the air bottle is swapped out for a fresh air bottle on a fairly frequent basis, it would be advantageous if there was an easy way to transfer the pack identifier from one air bottle to another.

FIG. 1 shows a fire fighter in full protective gear with an air bottle B strapped to his back and with a prior art pack identifier PI on his air bottle B (in this particular instance, the pack identifier reads “E 8”). The pack identifier PI is attached to the bottle B by the bottle retention strap.

Accordingly, it can be seen that a need exists for an improved firefighter identification system. It is to the provision of solutions to this and other problems that the present invention is primarily directed.

### SUMMARY OF THE INVENTION

Briefly described, in a first preferred form the invention relates to a firefighter identification system for use with a firefighter's cylindrical air bottle. The firefighter identification system includes a C-shaped metal band adapted to be slipped or snapped onto the cylindrical air bottle and having an outer surface. The system also includes one or more removable labels adapted to be removably placed on the C-shaped metal band.

Optionally, the removable labels can comprise flexible adhesive-backed labels. Also optionally, the removable labels can comprise flexible magnetic labels.

Preferably, the removable labels are photoluminescent, with reflective text. Optionally, the photoluminescence and reflective material can be reversed.

Optionally, the C-shaped metal band comprises a spring steel band. Preferably, the C-shaped metal band comprises a spring steel band. Also, preferably the C-shaped metal band has flared or beveled ends to help ease the metal band over a cylindrical oxygen bottle.

### BRIEF DESCRIPTION OF THE DRAWINGS

FIG. 1 shows a fire fighter in full protective gear with an air bottle B strapped to his back and with a prior art pack identifier PI on his air bottle B.

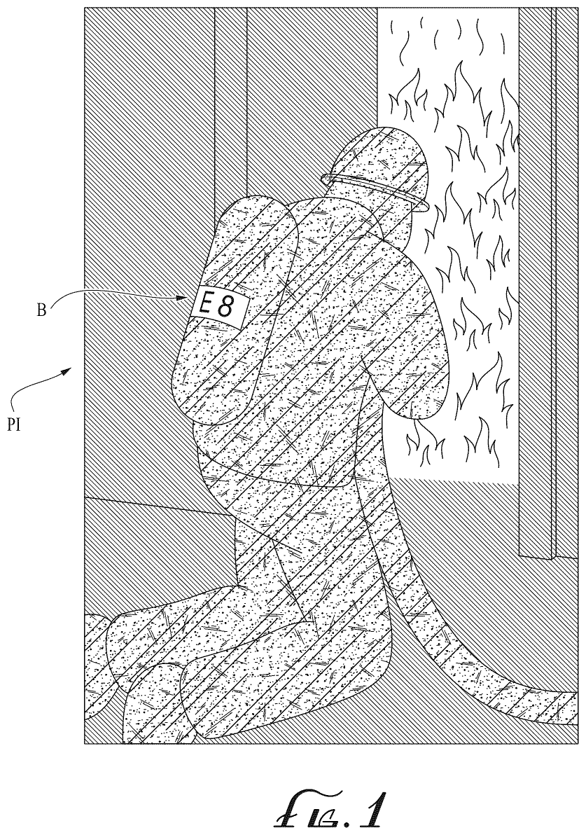

FIG. 2 is a perspective view of a firefighter identification system according to a first example form of the present invention.

FIG. 3 is a perspective view of a firefighter identification system of FIG. 2.

FIG. 4 is a front view of a firefighter identification system of FIG. 2 shown attached to an air bottle B, along with two prior art pack identifiers also shown attached to the air bottle B.

FIG. 5A is a front view of a pair of firefighter identification systems of FIG. 2 (in slightly different sizes) shown attached to an air bottle B, along with two prior art pack identifiers also shown attached to the air bottle B, after at least some of these have had exposure to high heat.

FIG. 5B is a front view of a firefighter identification systems of FIG. 5A shown attached to an air bottle B with prior art pack identifiers also shown attached to the air bottle B and shown in low light setting to illustrate the performance of the fire fighter identification system in comparison to prior art systems.

### DESCRIPTION OF EXAMPLE EMBODIMENTS

Generally described, the present invention relates to a firefighter identification system 10 for use with a firefighter's cylindrical oxygen bottle B. The firefighter identification system 10 includes a C-shaped metal band 20 adapted to be slipped or snapped onto the cylindrical air bottle B and having an outer surface 21. The system also includes one or more removable labels 30 adapted to be removably placed on the C-shaped metal band 20.

Optionally, the removable labels 30 can comprise flexible adhesive-backed labels. Also optionally, the removable labels can comprise flexible magnetic labels.

Preferably, the removable labels are photoluminescent, with reflective text. Optionally, the photoluminescence and reflective material can be reversed.

Optionally, the C-shaped metal band 20 comprises a spring steel band. Preferably, the C-shaped metal band comprises a heat-tempered spring steel band. Also, preferably the C-shaped metal band has flared or beveled ends 22, 23 to help ease the metal band over a cylindrical oxygen bottle B. The band 20 preferably is uniform in height, except in the vicinity of the flared ends 22, 23, where the band tapers slightly at the top and bottom, as at 25, 27.

The C-shaped metal band 20 preferably comprises a heat-tempered spring steel band, and enables the user to easily attach and remove the C-shaped metal band to and from the air bottle B. Note that as the metal band 20 is pushed over the bottle B, the flared ends 22 and 23 move apart from one another as they approach the maximum dimension of the bottle B and then move back toward one another as the band moves fully onto the bottle B. Once on the bottle B, the band 20 is snugly and securely held thereon by the spring force of the spring steel band. It remains on until the user removes it. In this regard, the outwardly extending portions 28, 29 of the flared ends 22, 23 act as handles to help the user pull the band 20 off of the bottle B.

Optionally, the C-shaped metal band 20 is made of 1095 spring steel which has been annealed and heat treated. The band 20 can take various forms and be made from various materials. In the particular commercial embodiment envisioned at this time, the band has a thickness of 0.035 inches and has an overall length of about 14 inches. The commercial embodiment has a width of about 2½ inches. These dimensions permit the band to fit snugly on a range of commonly used air bottles. Those skilled in the art will recognize that different materials can be used, different thicknesses can be used, different lengths and widths can be used.

Optionally, the C-shaped metal band 20 can be provided with a plurality of patches or pads mounted to the backside of the band 20, such as adhesive pads or patches 24a, 24b. These patches or pads serve to help keep the metal band from sliding around on the air bottle B.

Preferably, the label has an adhesive backing and carries photoluminescent indicia. The use of photoluminescence allows the indicia to be read in low light or no light situations. Such low light or no light situations are often encountered in firefighting such that the photoluminescence of the label is desirable. Preferably, the “field” of the indicia label 30 is photoluminescent and is provided with large reflective text. Optionally, the photoluminescence and reflective material can be reversed.

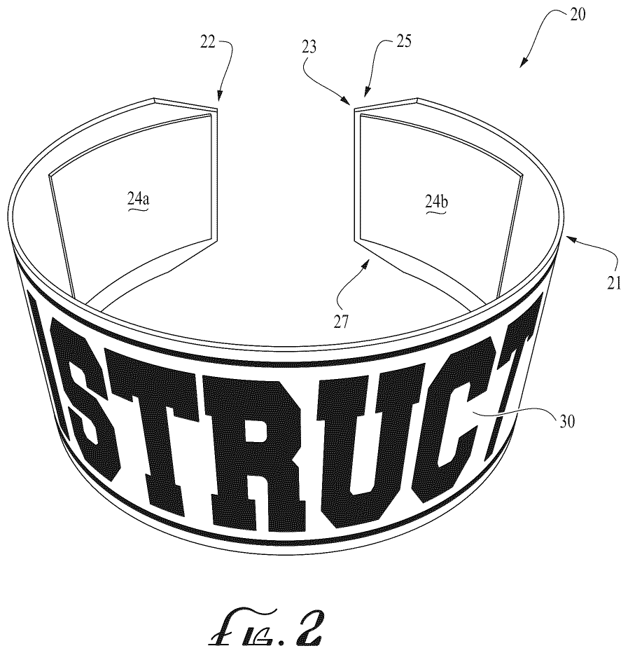

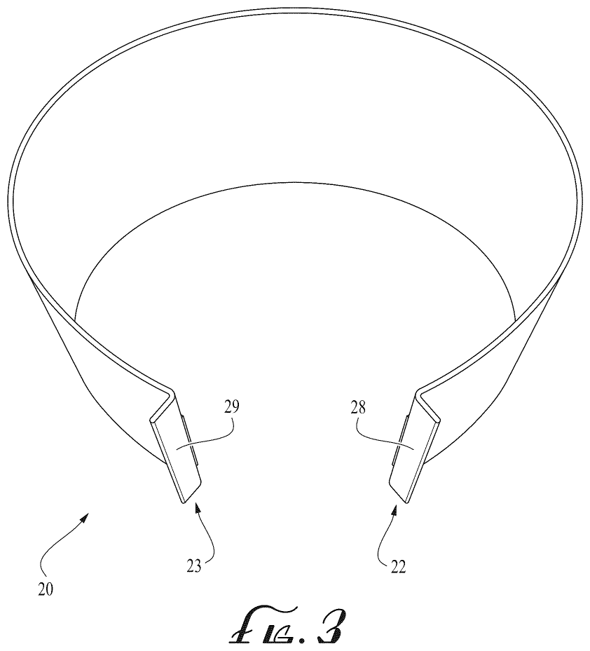

FIG. 2 is a perspective view of a firefighter identification system according to a first example form of the present invention. FIG. 3 is a perspective view of a firefighter identification system of FIG. 2.

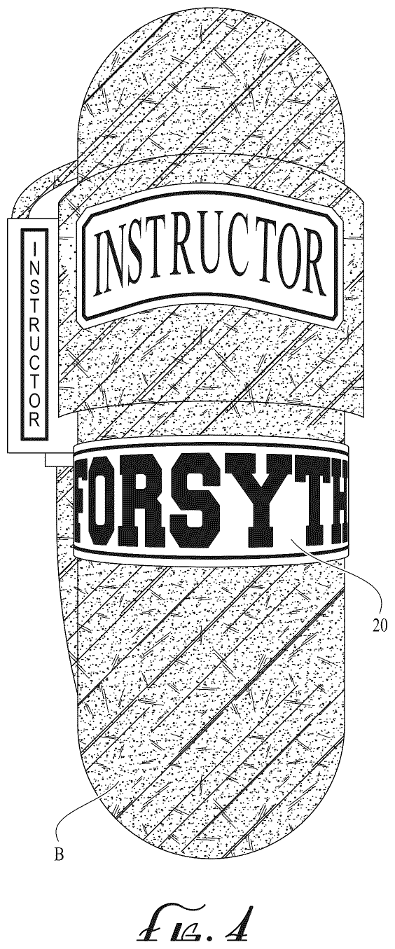

FIG. 4 is a front view of a firefighter identification system of FIG. 2. As shown in this figure, the snap band 20 or bottle band 20 has complete contact with the air bottle B, which makes it a solid assemblage and can withstand much more heat, giving it a longer product life. In essence, heat absorbed by the label and the band is transferred to the bottle B, with the bottle B essentially acting like a large heat sink. Once the bottle band 20 has taken significant damage overtime, the photoluminescent decal 30 attached thereto can be removed and replaced with a new decal. In this way the band can be reused many times.

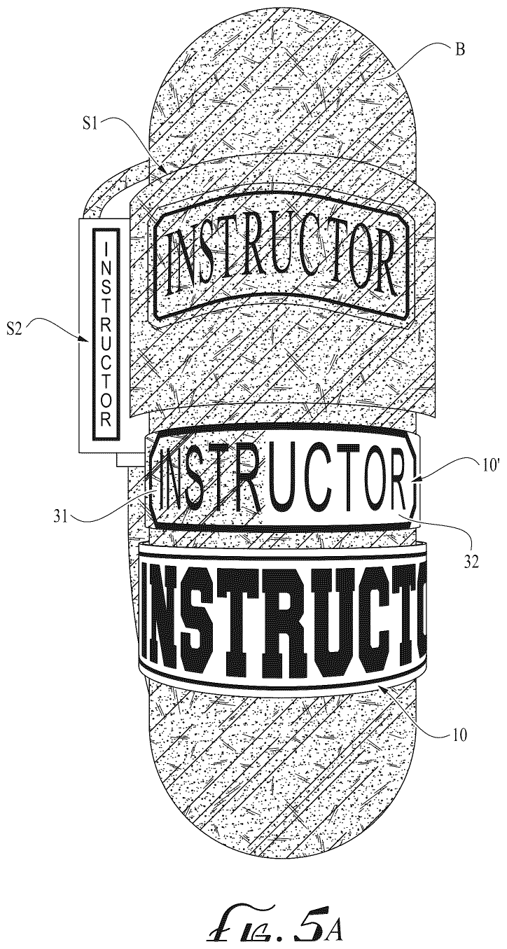

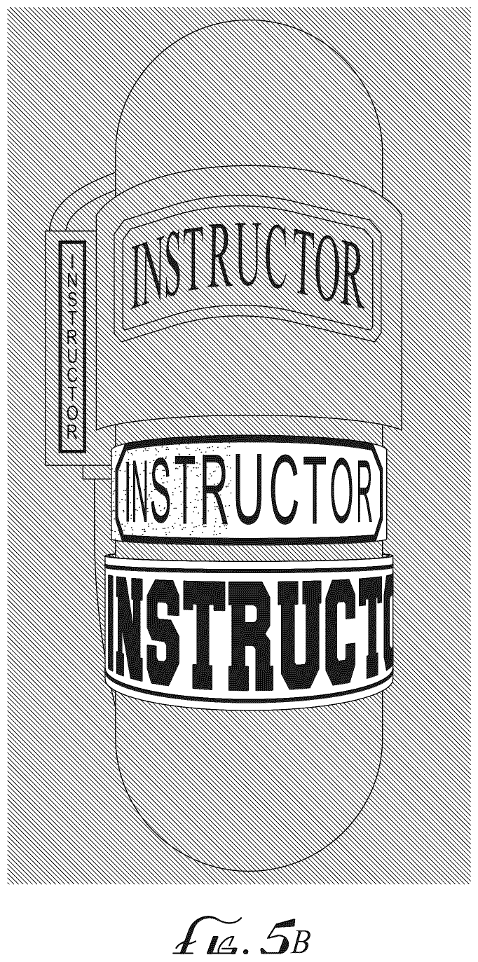

FIG. 5A is a front view of an air bottle B showing a pair of prior art firefighter identification systems S1 and S2 mounted thereon after exposure to high heat. This figure also shows two firefighter identification systems 10, 10′ of the present invention mounted to the lower part of the bottle B. As shown in this figure, a pack identifier of S1 has been exposed to very high temperatures multiple times and the damage is severe such that the pack identifier needs to be replaced. Such a prior pack identifier is exposed to high temperature air from both sides of the pack identifier (front and back), resulting in a relatively short service life. The pack identifier of S2 is not damaged significantly by the high heat but is relatively cumbersome to change out.

As noted above, FIG. 5A also shows two firefighter identification systems 10′ of the present invention mounted to the lower part of the bottle B. System 10′ is a 2-inch band and the left portion thereof shows the effects of heat thereon, while the right side thereof shows a right portion that has been renewed with a new adhesive label. This shows the contrast between heat damage on the novel firefighter identification system 10′ of the present invention compared to the prior art system of S1. Also shown in FIG. 5A is a new 2.5-inch band in system 10 (shown below system 10′). Note that as compressed air is drawn out of the bottle B by the breathing of the fire fighter, the release (expansion) of gas causes the compressed air in the bottle to cool the bottle, which helps to keep the ambient heat of the fire from damaging the label 30 on the band 20, thereby extending the service life of the adhesive-backed labels 30.

FIG. 5A thus depicts damage levels after exposure to high heat and showing one decal portion of the system having been replaced with a fresh decal. In this figure, the metal band 20 has been used in heavy fire conditions with high heat. The decal portion 31 on the left side of the band shows the type of damage or deterioration of the label 31 when exposed to high heat and smoke in firefighting conditions. The label portion 32 on the right of the band 20 is a replacement portion and the two are presented in this figure to show the difference in appearance and visibility between a new label portion 32 and an old, damaged or deteriorated label portion 31. Because it is so easy to remove label 30 and replace it with a new label, damaged or deteriorated labels can he replaced as frequently as desired.

FIG. 5B is another front view of a firefighter identification system of FIG. 5A and shows the various prior art systems and the novel firefighter identification systems 10, 10′ in use in low light environment. Thus, this figure depicts in schematic, relative terms how the various systems glow in the dark.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the specific sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A firefighter identification system for use with a firefighter's cylindrical oxygen bottle, comprising:
a C-shaped metal band adapted to be slipped or snapped onto the cylindrical oxygen bottle and having an outer surface; and
one or more removable labels adapted to be removably placed on the C-shaped metal band.

2. The firefighter identification system as claimed in claim 1 wherein the removable labels comprise flexible adhesive-backed labels.

3. The firefighter identification system as claimed in claim 1 wherein the removable labels comprise flexible magnetic labels.

4. The firefighter identification system as claimed in claim 1 wherein the removable labels are photoluminescent.

5. The firefighter identification system as claimed in claim 1 wherein the C-shaped metal band comprises a spring steel band.

6. The firefighter identification system as claimed in claim 1 wherein the C-shaped metal band has flared or beveled ends to help ease the metal band over a cylindrical oxygen bottle.
